(19) United States
(12) Patent Application Publication
(10) Pub. No.: US 2003/0174756 A1
(43) Pub. Date: Sep. 18, 2003

(54) Protective cap for a thermocouple in a gasifier

(76) Inventor: John Corwyn Groen, Fishkill, NY (US)

Correspondence Address: RODMAN RODMAN, 7 SOUTH BROADWAY, WHITE PLAINS, NY, 10601

(21) Appl. No.: 10/100,606

(22) Filed: Mar. 18, 2002

(51) Int. Cl. G01K 1/14

(52) U.S. Cl. 374/141; 374/179

(57) ABSTRACT

The protective cap for a thermocouple in a gasifier is installed at an opening of a thermocouple cavity in a hot-face lining of the reaction chamber of the gasifier. The cap is a generally disc-shaped structure that, in one embodiment, includes an upper slag deflecting surface and a lower receding surface. Slag is deflected by the slag deflecting surface over the receding surface to bypass the receding surface. A counterbore is formed in the refractory lining to accommodate the protective cap and to enable the protective cap to be recessed in the refractory lining. Holes can be formed in the cap with an upward incline to minimize the possibility of downwardly moving slag flowing through the holes into the thermocouple cavity. The holes can be made small enough to minimize the risk of allowing excessive radiant heat from reaching the gasifier vessel or shell. A peripheral edge of the cap has upper and lower portions that slope downwardly to help maintain the cap in its position in the counterbore.

### BACKGROUND OF THE INVENTION

This invention relates to gasifiers and more particularly to a novel cap device and method for protecting a thermocouple and the proximal vessel shell of a gasifier in the vicinity of the thermocouple.

Gasifiers of the type shown in U.S. Pat. Nos. 2,809,104 and 5,484,554 process carbonaceous fuels including coal, petroleum coke, gas and oil to produce gaseous mixtures of hydrogen and carbon monoxide, known variably as synthesis gas, coal gas, reducing gas and fuel gas.

The housing of a gasifier usually includes an outer reactor shell or vessel formed of steel and lined on the inside with one or more layers of insulating and refractory material such as fire clay and fire brick, also referred to as refractory lining or refractory brick. The inside space of the gasifier includes a reaction chamber wherein the conversion of carbonaceous fuel to gas takes place. Typical gasifier operating temperatures can range from approximately 2200° F. to 3000° F. Typical gasifier operating pressures can range from 10 to 200 atmospheres.

If temperatures in a gasifier rise above predetermined limits, the inside refractory lining can melt and thereby render the steel gasifier shell unprotected from potentially damaging heat conditions. If the operating temperatures in the gasifier decrease below predetermined limits, the gasification conversion rate from carbonaceous fuel to gas can have a low operating efficiency resulting in inadequate gas production. Information relating to temperature inside the gasifier is thus an important indicator of whether optimum gasification conditions exist. In carrying out the measurement of temperature inside the gasifier it is well known to install one or more thermocouples at one or more levels in the refractory lining of the gasifier.

Thermocouples are often provided at midlevel and/or lower sidewall level sections of a gasifier. Temperature measurement at these levels can also be used to extrapolate information regarding operating conditions at other levels of the gasifier. The number of thermocouples used normally depends on the type of feedstock provided in the gasifier, such as coal or light oil, and the amount of slag that is produced. High slagging gasifiers may employ eight thermocouples, for example, whereas low slagging units or non-slagging units may use only two thermocouples, for example.

In one known gasifier an elongated thermocouple cavity accommodates an elongated thermocouple that extends through the gasifier shell and the inner refractory lining to the reaction chamber. One end of the thermocouple is supported on the gasifier shell and an opposite end of the thermocouple is recessed from a heat exposed surface of the refractory lining, known as the hot-face surface. The cross-sectional area of the thermocouple cavity is usually kept as small as possible to prevent excessive heat from reaching the gasifier shell through the thermocouple cavity.

In some known gasifiers, the refractory lining includes one or more adjacent layers of refractory material such as refractory brick. Refractory brick is known to expand as it heats up from ambient temperature to the operating temperature of the gasifier. The refractory brick thus “moves” relative to the gasifier shell during thermal expansion because of temperature and coefficient of thermal expansion differences between the refractory lining and the gasifier shell. A thermocouple cavity in the refractory lining will also move relative to the gasifier shell as a consequence of thermal expansion of the refractory lining.

Since the thermocouple is fixed to the gasifier shell, thermal expansion of the refractory brick lining will usually result in a relative change of position between the thermocouple and the thermocouple cavity. The thermocouple cavity thus has an ambient temperature position relative to the thermocouple corresponding to an ambient temperature condition of the gasifier. The thermocouple cavity also has an operating temperature position relative to the thermocouple that is different from the ambient temperature position and corresponds to the operating temperature condition of the gasifier.

It is well known that molten slag forms on the hot-face surface of the refractory lining in the gasifier during the conversion of numerous carbonaceous fuels to gas. Molten slag usually flows downwardly along generally vertical portions of the hot-face surface. Downwardly moving slag can migrate into the generally horizontal thermocouple cavity through the cavity opening in the hot-face surface of the refractory lining. Slag that enters the thermocouple cavity will partially fill or completely clog the clearance space in the thermocouple cavity between the thermocouple and the wall of the thermocouple cavity.

Once clearance is reduced or eliminated around the thermocouple by slag accumulation any movement of the thermocouple cavity relative to the thermocouple due to expansion or contraction of the refractory lining can cause solidified slag in the thermocouple cavity to exert a force that is vertically directed up or down against the thermocouple. Such force can cause shearing of the thermocouple which is relatively immovable since it is supported on the gasifier shell.

Gasifiers occasionally need maintenance or repair. Some repairs are best accomplished after the gasifier is cooled down from operating temperature to ambient temperature. During the cool down stage, the refractory lining contracts. Such contraction causes a change in position of the thermocouple cavity relative to the thermocouple. Thus, during cool down of the gasifier, thermocouple damage can occur, especially if the thermocouple cavity is clogged with solidified slag.

As previously mentioned movement of the refractory lining during cool down causes the slag in a slag-clogged thermocouple cavity to push against the relatively fixed thermocouple and exert a force against the thermocouple. Thus contraction induced forces imposed on the thermocouple by slag in the thermocouple cavity when the gasifier is cooled down for repairs unrelated to the thermocouple may also cause damage or shearing of one or more thermocouples and necessitate removal and replacement of the damaged thermocouples.

Thermocouple repair or replacement may also require a clean out of hardened slag that has accumulated in the thermocouple cavity. Removal of the solidified slag from the thermocouple cavity and reinstallation of a replacement thermocouple is a time consuming and expensive procedure.

It is thus desirable to obviate the problems of slag migration into the thermocouple cavity opening and clogging of the thermocouple cavity with slag. It is also desirable to minimize transmission of heat from the reaction chamber to the shell of the gasifier through the thermocouple cavity whether or not the gasifier produces slag. In addition, it is desirable to protect the vessel or shell of the gasifier in the vicinity of the thermocouple cavity.

### OBJECTS AND SUMMARY OF THE INVENTION

Among the several objects of the invention may be noted the provision of a novel gasifier having protection for a thermocouple and a thermocouple cavity and the vessel or shell of the gasifier in the vicinity of the thermocouple cavity, a novel cap device for protecting a thermocouple and a thermocouple cavity in a gasifier and the vessel or shell of the gasifier in the vicinity of the thermocouple cavity, a novel countersunk cap for forming a protective covering for a thermocouple cavity opening in a gasifier, a novel cap device for protecting a thermocouple cavity in a gasifier, the cap having holes for transmission of limited heat through the cap, a novel protective cap for a thermocouple in a gasifier, the cap having an inclined front surface portion to divert slag away from other surface portions of the cap, a novel protective cap for a thermocouple in a gasifier, the cap having an outer surface with a slag diverting section and a receding section over which slag is diverted, a novel protective cap for a thermocouple in a gasifier, the cap having a slag diverting section and a receding section over which slag is diverted, the receding section having holes, a novel protective cap for a thermocouple in a gasifier, the cap having a slag diverting section and a receding section over which slag is diverted, the receding section having holes inclined upwardly to minimize the possibility of downwardly flowing slag passing through the holes, and a novel method of protecting a thermocouple in a gasifier and the vessel or shell of the gasifier in the vicinity of the thermocouple cavity.

Other objects and features of the invention will be in part apparent and in part pointed out hereinafter.

In accordance with the invention a protective cap for a thermocouple and a thermocouple cavity in a gasifier is installed at an opening of the thermocouple cavity in a hot-face lining of the reaction chamber of the gasifier.

In a preferred embodiment of the invention the protective cap is a generally disc-shaped structure that includes an upper slag deflecting surface and lower receding surface. Slag is thus deflected by the deflecting surface over the receding surface to bypass the receding surface. The receding surface can be provided with one or more holes that communicate with the thermocouple cavity. More than one hole may facilitate manipulation of the cap, and apart from this consideration one hole is also feasible. Preferably the hole(s) are inclined in an upward direction to minimize the possibility of slag and excessive heat flowing through the hole(s) into the thermocouple cavity. In gasifiers that do not produce slag the slag deflecting surface and lower receding surface can be replaced by a single planar surface.

A peripheral edge of the protective cap has upper and lower portions that slope downwardly from a front face of the cap to a rear face of the cap. A counterbore is preferably formed in the refractory lining to accommodate the protective cap and to enable the protective cap to be recessed in the refractory lining. The counterbore and the protective cap are of complementary shape. Under this arrangement the protective cap can be lowered into the counterbore such that the weight of the cap helps maintain the cap in its position in the counterbore.

In another embodiment of the invention the hole(s) in the protective cap can be omitted since heat transfer through the cap to the thermocouple will provide requisite, although proportionally reduced heat information to the thermocouple. The protective cap, without openings, also ensures that no slag will enter the thermocouple cavity.

The invention further includes a method of protecting a thermocouple in a gasifier. The method includes forming a thermocouple cavity that extends through a shell of the gasifier, through the refractory lining on the gasifier shell and through a hot-face surface of the refractory lining to define a thermocouple opening at the hot-face surface. The method further includes providing a cap at the thermocouple opening in a covering position to cover the thermocouple opening and thereby prevent molten slag that moves downwardly on the hot-face surface from entering the thermocouple cavity through the thermocouple opening. The method further includes forming a counterbore at the thermocouple opening to enable the protective cap to be recessed a predetermined amount in the thermocouple opening.

Further aspects of the method include providing the cap with a slag deflecting surface and a receding surface. Other aspects of the method include the formation of through hole(s), in the cap, and locating the hole(s) in the receding surface of the cap at an upward inclination from a front surface of the cap toward a rear surface of the cap. The method further includes providing a peripheral edge of the cap with upper and lower portions that slope downwardly from a front face of the cap to a rear face of the cap.

The invention also includes a method of protecting the vessel or shell of the gasifier in the vicinity of the thermocouple cavity by providing a cap at the thermocouple opening to minimize exposure of the vessel or shell of the gasifier to radiant heat from within the gasifier that would otherwise pass through the thermocouple cavity to the vessel or shell of the gasifier.

The invention accordingly comprises the constructions and methods hereinafter described, the scope of the invention being indicated in the claims.

### DESCRIPTION OF THE DRAWINGS

In the drawings,

FIG. 1 is a simplified fragmentary sectional view of an upper portion of a gasifier with thermocouples in thermocouple cavities that are open at the refractory lining;

FIG. 2 is an enlarged fragmentary sectional view thereof;

FIG. 3 is a fragmentary sectional view taken on the line 3-3 of FIG. 2;

FIG. 4 is a fragmentary sectional view taken on the line 4-4 of FIG. 2;

FIG. 5 is a fragmentary sectional view taken on the line 5-5 of FIG. 2;

FIG. 6 is an enlarged fragmentary sectional view of a thermocouple in a thermocouple cavity with a protective cap incorporating one embodiment of the present invention;

FIG. 7 is a perspective view of the protective cap before it is installed in refractory blocks of the refractory lining of the gasifier, with the extent of the thermocouple and the thermocouple cavity in the refractory blocks being shown in dotted outline;

FIG. 8 is a view similar to FIG. 7 with the protective cap installed in the refractory blocks, the dotted outline of the extent of the thermocouple and the extent of the thermocouple cavity being omitted for purposes of clarity;

FIG. 9A is a perspective view of the lower refractory block of FIG. 7;

FIG. 9B is a top plan view thereof;

FIG. 9C is a front elevational view thereof;

FIG. 9D is a sectional view taken on the line 9D-9D of FIG. 9C;

FIG. 10A is a perspective view of the upper refractory block of FIG. 7;

FIG. 10B is a top plan view thereof;

FIG. 10C is a front elevational view thereof;

FIG. 10D is a sectional view taken on the line 10D-10D of FIG. 10C;

FIG. 11A is a perspective view of the protective cap incorporating one embodiment of the invention;

FIG. 11B is a front elevational view thereof;

FIG. 11C is a top plan view thereof; and,

FIG. 11D is a sectional view taken on the line 11D-11D of FIG. 11B.

Corresponding reference characters indicate corresponding parts throughout the several views of the drawings.

### DETAILED DESCRIPTION OF THE INVENTION

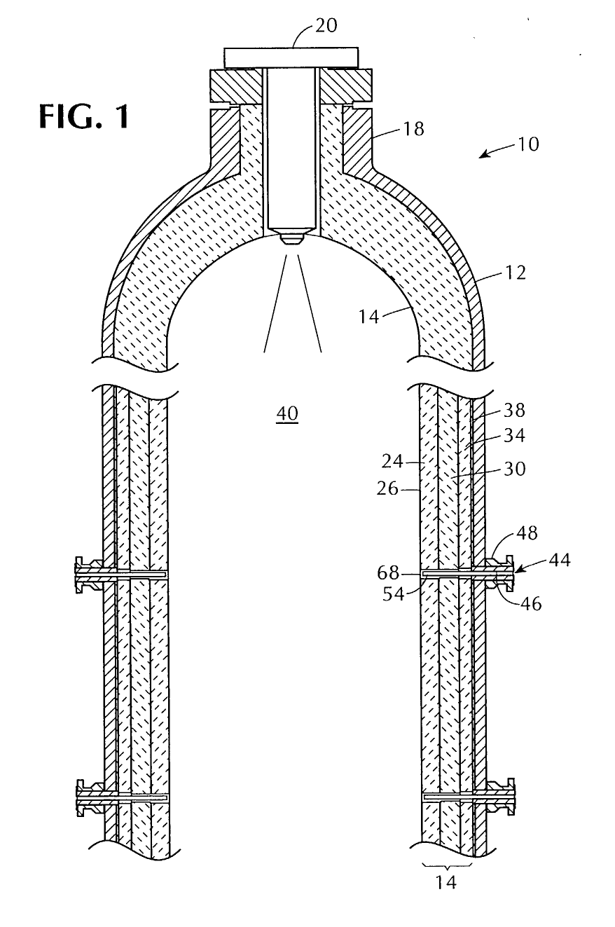

Referring to the drawings, a gasifier is generally indicated by the reference number 10 in FIG. 1.

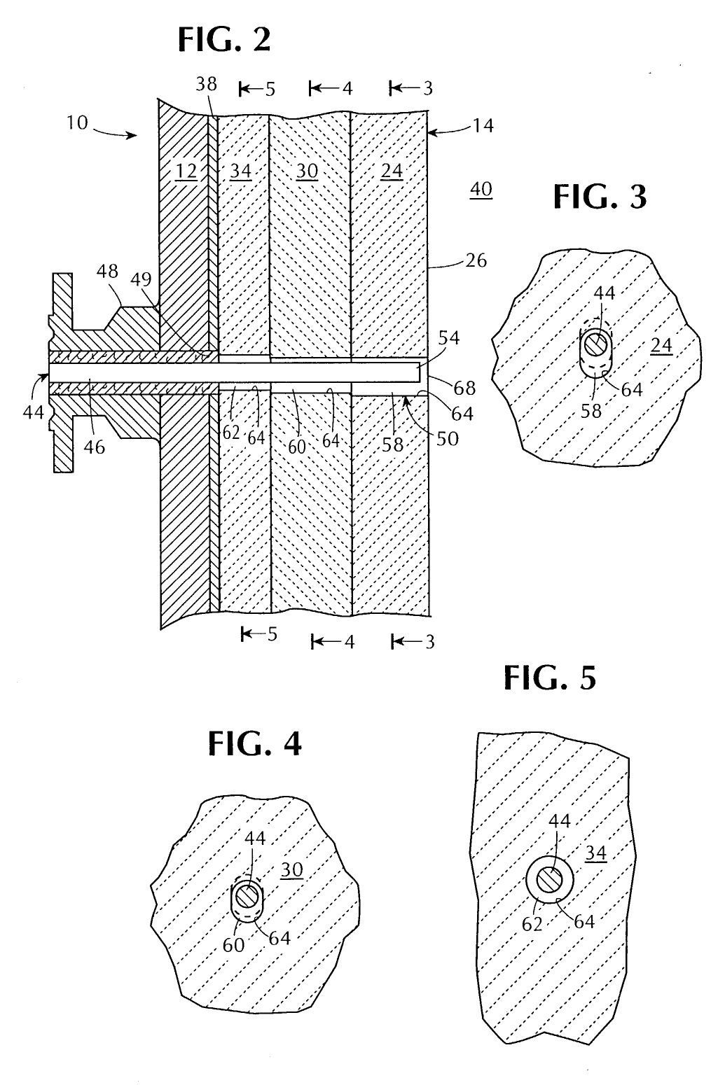

The gasifier 10 includes an outer reactor vessel or shell 12, preferably formed of steel, with an inner refractory lining 14 and a top neck portion 18 that supports a feed injector 20. The refractory lining 14 (FIGS. 1 and 2) includes, for example, a hot-face layer 24 of refractory brick with a hot-face surface 26, a backup layer 30 of refractory brick, and an outermost layer 34 of refractory brick. A layer of compressible refractory insulation 38 is provided between the outermost layer 34 and the gasifier shell 12.

The refractory lining 14 defines a reaction chamber 40 (FIG. 1) in the gasifier 10 that receives carbonaceous fuel from the feed injector 20 for conversion to synthesis gas or “syngas”. Portions of the gasifier below that shown in FIG. 1 are not shown in FIG. 1 since they can be of any suitable known construction and are not pertinent to an understanding of the invention.

The gasifier 10 is provided with a plurality of any suitable known commercially available thermocouples 44 (FIG. 2). The thermocouple 44 includes an end portion 46 supported in any suitable known manner at the entrance to a known thermocouple nozzle 48 and extends through a thermocouple opening 49 in the gasifier shell 12. The thermocouple nozzle 48 is welded to the gasifier shell 12 in any suitable known manner. The thermocouple 44, which extends through a thermocouple cavity 50 in the refractory lining 14, has a free end 54 that is recessed from the hot-face surface 26 of the refractory lining 14.

The thermocouple cavity 50 (FIG. 2) includes a cavity section 58 in the hot-face brick layer 24, a cavity section 60 in the backup brick layer 30 and a cavity section 62 in the outermost brick layer 34. The cavity section 62 generally aligns with the thermocouple opening 49 in the gasifier shell 12. The peripheral wall of the thermocouple cavity 50 is generally indicated by the reference number 64 and will be understood to include the wall or periphery of each of the cavity sections 58, 60 and 62 (FIGS. 3-5).

The thermocouple cavity 50 has an opening 68 (FIG. 2) at the hot-face surface 26, and in general the opening 68 is uncovered. Thus molten slag (not shown), which forms during gasification of numerous different feedstocks, moves downwardly along the hot-face surface 26 and can enter the opening 68 of the thermocouple cavity 50. Slag accumulation in the thermocouple cavity 50 will eventually reduce or eliminate the clearance space between the thermocouple 44 and the thermocouple cavity wall 64.

Generally, the amount of clearance provided between the thermocouple 44 and the thermocouple cavity wall 64 (FIGS. 2-5) is subject to several competing considerations. One consideration is that the clearance must be sufficient enough to avoid interference between the thermocouple 44 and the wall 64 of the thermocouple cavity sections 58, 60 and 62 during normal thermal expansion and contraction of the refractory layers 24, 30 and 34, as when the gasifier 10 heats up or cools down.

A further consideration regarding the selection of suitable clearance between the thermocouple 44 and the cavity wall 64 is that as the cross-sectional opening of the thermocouple cavity sections 58, 60 and 62 (also referred to as the thermocouple cavity 50) increases, there is a greater likelihood that slag will enter the thermocouple cavity 50 to a greater depth from the cavity opening 68 and reduce or eliminate the desired clearance.

Another concern regarding the selection of suitable clearance is that the greater the clearance space between the thermocouple 44 and the thermocouple cavity wall 64 the greater the risk of exposure of the gasifier shell 12 to heat from the reaction chamber 40 through the thermocouple cavity 50. If the gasifier shell 12 at the thermocouple opening 49 (FIG. 2) is not protected from process heat by the refractory lining 14 shell damage can occur.

The thermocouple cavity sections 58 and 60 (FIGS. 2-4) are usually elongated in a vertical direction of expansion of the refractory layers 24 and 30 to compensate for the normal range of vertical movement of the refractory layers 24 and 30 relative to the thermocouple 44.

Since the hot-face brick layer 24 is subjected to higher degrees of heat exposure and thermal expansion and contraction than the backup brick layer 30 or the outermost brick layer 34, a greater amount of vertical elongation or thermocouple clearance is provided in the cavity section 58 of the hot-face brick layer 24 than in the cavity sections 60 and 62 of the backup brick layer 30 and the outermost brick layer 34.

Referring to FIGS. 2-5, the position of the thermocouple 44 relative to the solid line thermocouple cavity sections 58 and 60 corresponds to an ambient temperature condition of the gasifier 10 before it is heated up to the operating temperature. During start-up operation of the gasifier 10 the refractory layers 24, 30 and 34, which are supported on a lower section of the gasifier (not shown) will generally expand in an upward direction as the gasifier heats up from an ambient temperature condition to operating temperature conditions.

Since the hot-face layer 24 (FIG. 1) is closer to the reaction chamber 40 than the layers 30 or 34 there will generally be greater expansion of the layer 24 than the layers 30 or 34 as the gasifier heats up from ambient temperature to operating temperature conditions. In a like manner there will generally be greater expansion of the layer 30 than the layer 34 since the layer 30 is closer to the reaction chamber 40 than the layer 34.

Thus, as shown in FIGS. 2 and 3 the ambient temperature position of the thermocouple 44 relative to the cavity section 58 in the layer 24 allows for a greater amount of vertical movement of the layer 24 to provide a greater amount of thermal expansion clearance below the thermocouple 44 than is provided in the cavity section 60 of the layer 30 (FIGS. 2 and 4), and the cavity section 62 of the layer 34 (FIGS. 2 and 5).

The operating temperature position of the thermocouple 44 relative to the thermocouple cavity sections 58 and 60 is shown dotted in FIGS. 3 and 4. The operating temperature position of the thermocouple 44 relative to the cavity section 62 (FIG. 5) is substantially the same during operating temperature conditions and ambient temperature conditions because the outermost layer of refractory brick 34 containing the cavity section 62 expands at substantially the same rate as the gasifier shell 12 which supports the thermocouple nozzle 48 and hence the thermocouple 44.

When molten slag (not shown) flows downwardly along the hot-face surface 26 it can enter the thermocouple cavity 50 through the cavity opening 68 (FIG. 2). Slag buildup in the thermocouple cavity 50 results in a reduction or elimination of clearance between the thermocouple 44 and the wall 64 of the thermocouple cavity 50. When the gasifier 10 is cooled down to ambient temperature conditions for maintenance or repair purposes contractile movement of the refractory linings 24 and 30 will occur in a downward direction. Any appreciable amount of slag in the thermocouple cavity 50 can thus exert a downward force against the thermocouple 44 thereby damaging or shearing the thermocouple 44.

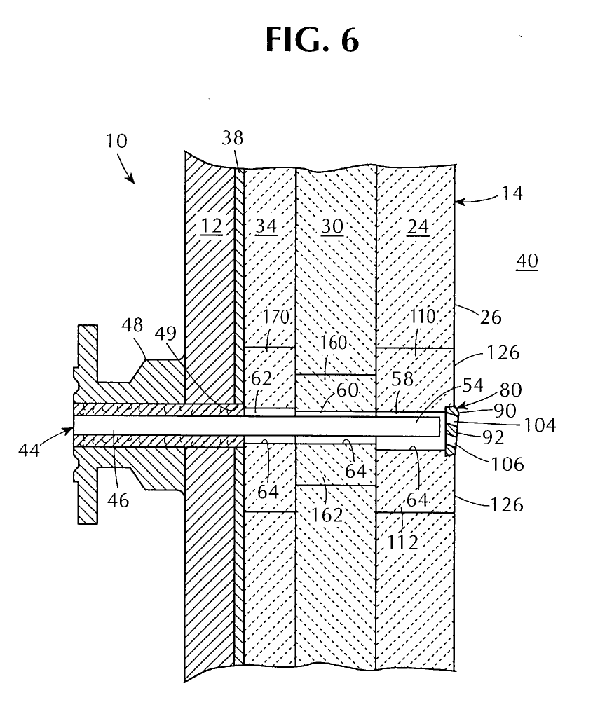

In response to the problem of slag buildup in the thermocouple cavity 50 and the problem of heat flow through the thermocouple cavity 50 to the gasifier shell 12, I provide a novel protective cap 80 (FIGS. 6-8 and 11A to 11D).

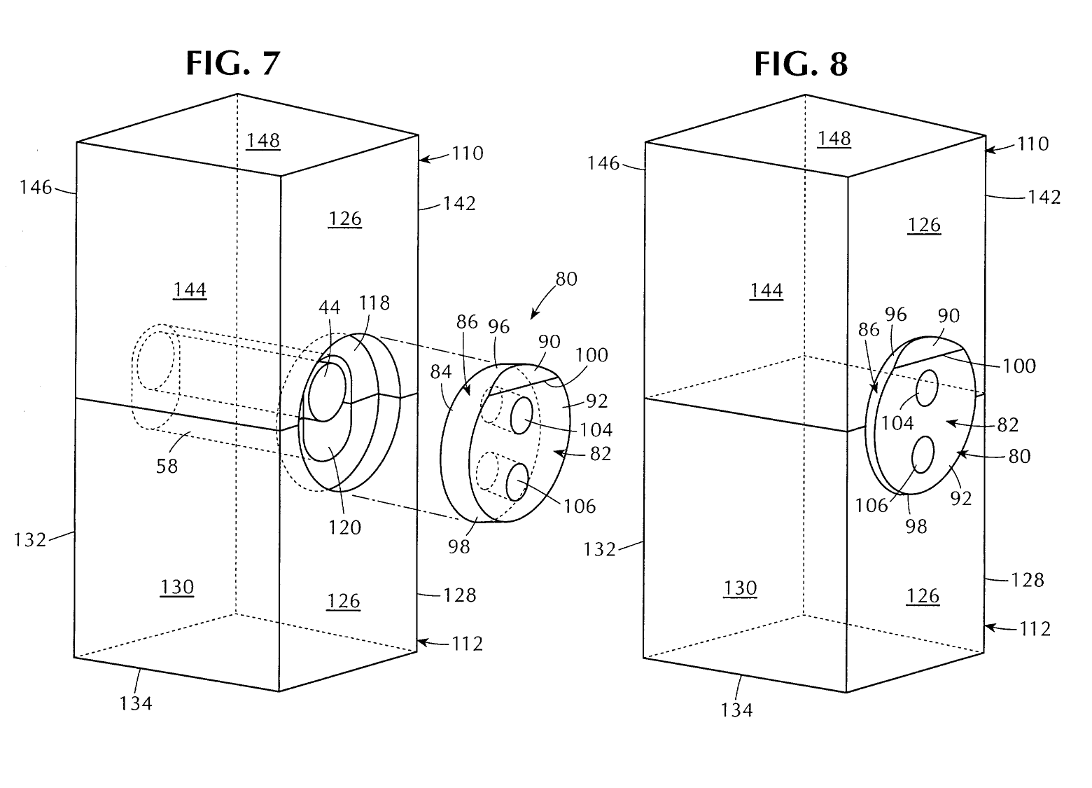

Referring to FIGS. 6 and 7 the protective cap 80 covers an opening 120 (FIG. 7) of the thermocouple cavity 58. The protective cap 80 protects the thermocouple 44, substantially eliminates the migration of slag into the thermocouple cavity 58 and restricts the flow of heat through the thermocouple cavity 58 to the gasifier shell 12. Preferably the protective cap 80 is recessed in the hot-face layer 24 at the hot-face surface 26 (FIG. 6).

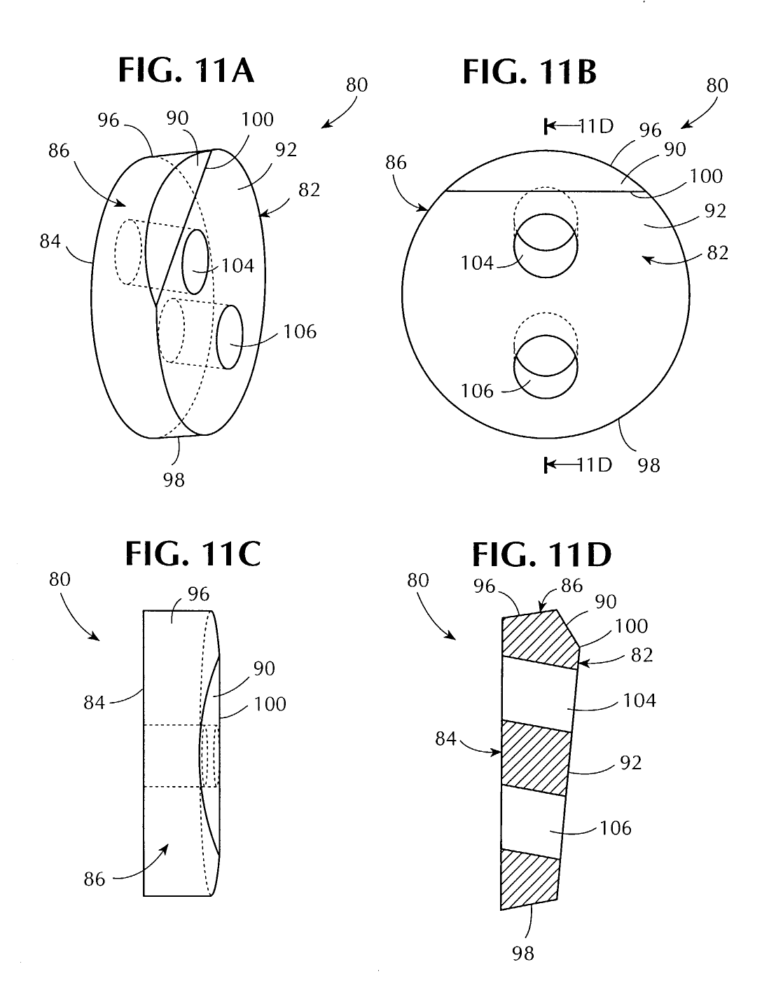

Referring to FIGS. 11A, 11B, 11C and 11D the protective cap 80 is a generally disc-shaped structure which can be formed of dense alumina. The cap 80 has a front face 82, a generally planar vertical rear face 84 and a peripheral edge 86 between the front face and the rear face. The front face 82 includes an upper slag diverting section 90 that is inclined away from the rear face 84 in a downward vertical direction when the cap is in a selected orientation as shown in FIG. 8. The front face 82 also includes a receding section 92, below the slag diverting section 90. The receding section 92 is inclined toward the rear face 84 in a downward direction when the cap 80 is in the selected orientation as shown in FIG. 8. Preferably the slag diverting section 90 is of smaller area than the receding section 92.

The peripheral edge 86 of the cap 80, as most clearly shown in FIG. 11D, has an upper portion 96 and a lower portion 98 that slope downwardly from the front face 82 to the rear face 84 when the cap is in the selected orientation as shown in FIGS. 6-8. Under this arrangement the cap 80 has a maximum thickness where the slag diverting section 90 and the receding section 92 intersect at the intersection line 100 (FIG. 11D).

A pair of holes 104 and 106 (FIGS. 11A and 11D) extend through the front face 82 to the rear face 84 and are inclined upwardly from the front face 82 to the rear face 84 when the cap 80 is in the selected orientation of FIGS. 6-8. Preferably the holes 104 and 106 are located in the receding section 92 (FIG. 11B) of the front face 82. It should be noted that the two holes 104 and 106 can facilitate manipulation of the cap 80 during installation and removal, if necessary. It is also feasible to provide a single hole in the cap 80. A single hole provided in the cap 80 at the receding section 92 would also permit using a higher inclination angle for the hole than is possible with the two holes 104 and 106 as shown. A cap without holes might also be feasible.

Referring to FIGS. 7 and 8 the thermocouple cavity 58 is preferably formed in upper and lower refractory blocks 110 and 112 which can be formed of dense alumina, each block including a portion of the cavity 58. It has been found that the two separate blocks 110 and 112, are easier to handle and install in the hot-face layer 24 than one block (not shown) containing the cavity 58.

The thermocouple cavity 58 (FIG. 7) includes a counterbore 118 at the cavity opening 120. The counterbore 118 is of complementary shape with the rear face 84 and the peripheral edge 86 of the cap 80. The protective cap 80 can thus be lowered into the counterbore 118 such that the weight of the cap 80 helps maintain the position of the cap 80 in the counterbore 118 because of the downwardly inclined portions 96 and 98 of the peripheral edge 86. If desired, refractory cement (not shown) can be provided at the surface of the counterbore 118 and at the periphery 86 of the cap 80 to further secure the cap 80 in the counterbore 118.

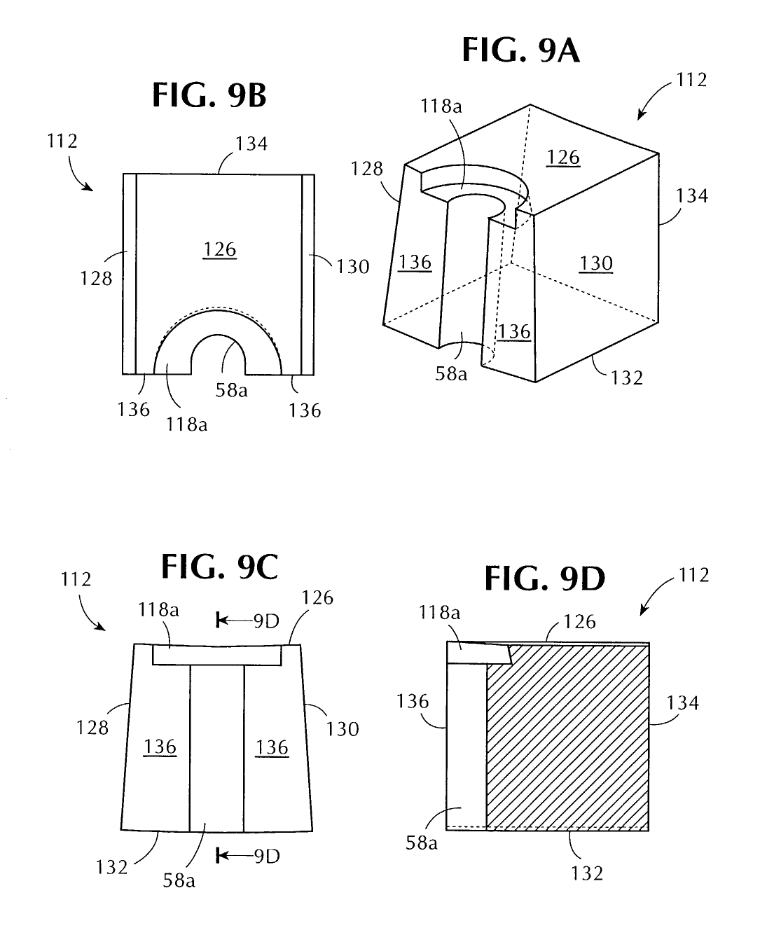

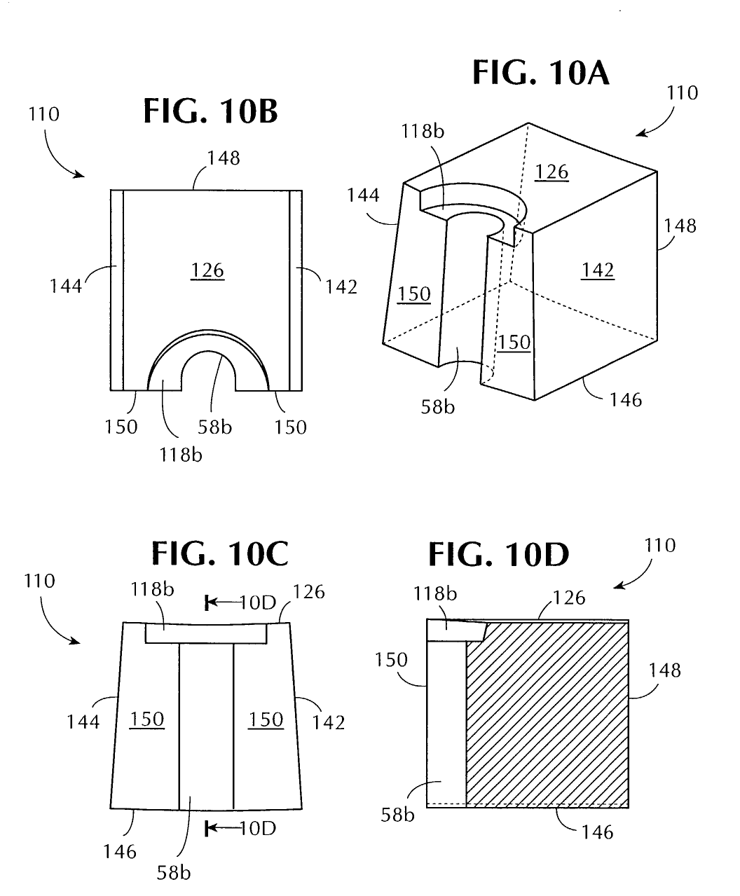

Although the size of the protective cap 80 depends in part on the size of the thermocouple 44 and the thermocouple blocks 110 and 112 (FIGS. 9A and 10A), some dimensional examples for the protective cap 80 include a height of approximately 115 mm for the rear face 84, a distance of approximately 100 mm from the line of intersection 100 to the lower peripheral edge portion 98 and a distance of approximately 17 mm from the line of intersection 100 to the upper peripheral edge portion 96. The circular portion of the receding section 92 of the front face 82 has a width of approximately 113 mm. The angle between the slag diverting section 90 and the receding section 92 is approximately 145°. The angle between the slag diverting section 90 and the upper peripheral edge portion 96 is approximately 110°. The angle between the receding section 92 and the lower peripheral edge 98 is approximately 105°. The angle between the upper peripheral edge 96 and the rear face 84 is approximately 100°. The angle between the lower peripheral edge 98 and the rear face 84 is approximately 80°. The upper and lower peripheral edges 96 and 98 are approximately 22 mm thick and the holes 104 and 106 are approximately 25 mm in diameter and make an angle of approximately 80° with the rear face 84. The distance between the holes 104 and 106 on the front face 92 can be approximately 24 mm.

Referring to FIGS. 9A to 9D the lower refractory block 112 includes a hot-face surface portion 126 and a semi-counterbore portion 118a that is complementary to the lower peripheral edge portion 98 of the protective cap 80. The lower refractory block 112 also includes a lower section 58a of the cavity 58 and opposite sidewalls 128 and 130 that have a slight taper from the hot-face surface portion 126 to a rear-face portion 132. The hot-face surface portion 126 (FIG. 9C) is slightly concave from the sidewall 128 to the sidewall 130 and the rear face portion 132 is slightly convex from the sidewall 128 to the sidewall 130 because the thermocouple block 112 is provided at the refractory lining 14 where said lining has a cylindrical shape. The tapered sidewalls 128 and 130 help lock the lower refractory block 112 in the hot-face layer 24 where the refractory lining 14 is of cylindrical shape. The lower refractory block 112 also includes a bottom surface 134, and a top surface 136 that confronts the upper refractory block 110.

Referring to FIGS. 10A to 10D the upper refractory block 110 includes a concave hot-face surface portion 126 similar to that of the thermocouple block 112 and a semi-counterbore portion 118b that is complementary to the upper peripheral edge portion 96 of the protective cap 80. The upper refractory block 110 also includes an upper section 58b of the cavity 116 and opposite sidewalls 142 and 144 that have a slight taper from the hot-face surface portion 126 to a rear-face portion 146 similar to that of the sidewalls 128 and 130 of the thermocouple block 112. The rear face portion 146 is convex similar to that of the rear face portion 132 of the thermocouple block 112. The tapered sidewalls 142 and 144 help lock the upper refractory block 110 in the hot-face layer 24 where the refractory lining 14 is of cylindrical shape. The upper refractory block 110 also includes a top surface 148, and a bottom surface 150 that confronts the top surface 136 of the lower refractory block 112.

The size of the upper thermocouple block 110 can be for example, approximately 155 mm wide at the hot-face surface 126 between the sidewalls 142 and 144 and approximately 180 mm wide at the rear face 146 between the sidewalls 142 and 144. The sidewalls 142 and 144 are inclined approximately 4° from the hot-face surface 126 to the rear face 146. The distance between the hot-face surface 126 and the rear face 146 is approximately 175 mm and the distance between the bottom surface 150 and the top surface 148 is approximately 190 mm. The cavity section 58b has a curved portion with a radius of approximately 25.6 mm that is recessed approximately 13 mm from the bottom surface 150 such that the distance between the bottom surface 150 and the bottom of the cavity section 58b is approximately 38 mm. The counterbore 118b (FIG. 10D) has a radius of approximately 57 mm and the wall of the counterbore is inclined at an angle of approximately 80°.

The size and angular relationships for the lower thermocouple block 112 are substantially the same as for the upper thermocouple block 110 except for the wall of the counterbore (FIG. 9D) which is inclined at an angle of approximately 100°.

The cavity 60 in the backup brick layer 30 can be formed in two thermocouple blocks 160 and 162 (FIG. 6) that each include a portion of the cavity 60. The thermocouple blocks 160 and 162 are constructed in a manner similar to that described for the thermocouple blocks 110 and 112. However, the thermocouple blocks 160 and 162 can be made smaller than the thermocouple blocks 110 and 112 because there is no counterbore in the blocks 160 and 162 and because the elongation or clearance of the thermocouple cavity 60 need not be as large as the elongation or clearance of the thermocouple cavity 116.

The thermocouple cavity 62 in the outermost layer of brick 34 can be formed in one thermocouple block 170 (FIG. 6) since the cavity 62 can be of circular cross-section-and substantially does not move relative to the thermocouple 44. The thermocouple block 170 can be made taller than the thermocouple blocks 160 and 162 since the outermost layer of brick 34 is generally narrower than the hot face layer 24 or the backup layer of brick 30 and is generally of lower density than the hot-face thermocouple blocks 110 and 112.

When the protective cap 80 is installed in the counterbore 118 as shown in FIGS. 6-8 there is substantial closure of the cavity opening 120 except for the holes 104 and 106 in the cap 80. Any molten slag (not shown) that moves downwardly along the hot-face surface 26 (FIG. 6) in the direction of the protective cap 80 passes over the slag diverting section 90 for diversion away from the underlying receding section 92.

In the event that molten slag runs onto the receding section 92 it is likely to flow downwardly rather than upwardly and thus bypasses the upwardly inclined holes 104 and 106 in the receding section 92. The protective cap 80 thus reduces or eliminates flow of slag into the thermocouple cavity 58 and substantially reduces the transmission of heat from the reaction chamber 40 through the thermocouple cavity 58 to the gasifier shell 12.

Under this arrangement the thermocouple cavity 58 and the thermocouple 44 are substantially protected from migration of slag into the cavity 58. Thus the clearance space between the thermocouple 44, the thermocouple cavity 58 and the cavity sections 60 and 62 should remain free of slag that forms in the reaction chamber 40 during conversion of carbonaceous fuel to syngas.

Because the protective cap 80 substantially reduces the rate of heat transmission through the thermocouple cavity 58 and substantially reduces or eliminates the entry of slag into the thermocouple cavity 58 it may be feasible to provide a thermocouple cavity with greater clearance space for the thermocouple 44 than would be provided in the unprotected thermocouple cavity 50 of FIG. 2. Increased clearance in a thermocouple cavity would ensure safety of the thermocouple 44 under unexpected temperature extremes that cause additional thermal expansion of refractory brick.

The invention thus includes a novel method of protecting a thermocouple in a gasifier. The method includes forming a thermocouple cavity that extends through the refractory lining and through the gasifier shell such that a thermocouple opening is formed at a hot-face surface of the refractory lining. The method further includes providing a protective cap at the thermocouple cavity opening in a covering position to cover the thermocouple cavity opening and thereby prevent slag that is formed in the gasifier from entering the thermocouple cavity through the thermocouple cavity opening. The method further includes forming a counterbore at the thermocouple opening to enable the protective cap to be recessed a predetermined amount in the thermocouple opening.

Further aspects of the method include providing the protective cap with a slag deflecting surface and a receding surface. In other aspects the method also includes the formation of one or more through holes in the receding surface of the protective cap at an upward inclination from a front surface of the cap toward a rear surface of the cap. The method further includes providing a peripheral edge of the protective cap with upper and lower portions that slope downwardly from a front face of the cap to a rear face of the cap.

Some advantages of the invention evident from the foregoing description include a protective cap for a thermocouple and a thermocouple cavity in a gasifier that overcomes the problem of slag accumulation in the thermocouple cavity by reducing or preventing the flow of slag into the thermocouple cavity. Another advantage is that the protective cap reduces the transmission of heat from the reaction chamber of the gasifier through the thermocouple cavity to the gasifier shell. Still another advantage is that the protective cap has a slag deflecting surface and a receding surface and the slag deflecting surface deflects slag away from the receding surface of the cap. A further advantage is that the cap can include one or more holes that communicate with the thermocouple cavity to enable the thermocouple to monitor actual gasifier temperatures rather than compensated temperatures which result from the insulating effect of a cap. Relatively small holes in the cap minimize the possibility of thermal shock damage to the thermocouple that can occur without the cap.

Still another advantage is that the holes in the protective cap are inclined in an upward direction to prevent any slag that might flow onto the receding surface from migrating through the openings into the thermocouple cavity. Another advantage is that by protecting the thermocouple cavity with the protective cap to reduce or prevent slag from entering the thermocouple cavity it is possible to enlarge the thermocouple cavity without risk of slag penetration because the enlarged thermocouple cavity would have the protective cap. Thus use of the protective cap permits provision of greater amounts of clearance between the thermocouple and the thermocouple cavity than would be feasible without a protective cap.

In view of the above it will be seen that the several objects of the invention are achieved and other advantageous results attained. As various changes can be made in the above constructions and methods without departing from the scope of the invention, it is intended that all matter contained in the above description or shown in the accompanying drawings shall be interpreted as illustrative and not in a limiting sense.

What is claimed is:

1. A gasifier comprising,
a) a reactor shell,
b) a refractory lining on said reactor shell to define a reaction chamber in said reactor shell, said refractory lining including a hot-face surface,
c) a thermocouple cavity extending through said reactor shell through said refractory lining, and through said hot-face surface to define a thermocouple opening at said hot-face surface, and,
d) a cap at said thermocouple opening to cover said thermocouple opening to prevent excess process heat and any slag that forms in said reaction chamber on said hot-face surface from entering said thermocouple cavity through said thermocouple opening.

2. The gasifier as claimed in claim 1 wherein said cap has a front face corresponding to said hot-face surface and a rear face that confronts the thermocouple cavity when the cap is in a covering position at said thermocouple opening to cover said thermocouple opening, said front face having a slag diverting section that is inclined away from said rear face in a downward vertical direction when said cap is in said covering position.

3. The gasifier as claimed in claim 2 wherein said front face has a receding section that is below said slag diverting section when said cap is in said covering position, said receding section being inclined toward said rear face in an downward vertical direction when said cap is in said covering position.

4. The gasifier as claimed in claim 3 wherein a hole is formed in the receding section of said cap, said hole extending through said front face and said rear face and being inclined upwardly from said front face toward said rear face when said cap is in said covering position.

5. The gasifier as claimed in claim 3 wherein said receding section is of greater area than said slag diverting section.

6. The gasifier as claimed in claim 1 wherein said cap has a front face corresponding to said hot-face surface and a rear face that confronts the thermocouple cavity when the cap is positioned at said thermocouple opening to cover said thermocouple opening, said cap having a peripheral edge between said front face and said rear face, said peripheral edge having an upper portion and a lower portion when said cap is in said covering position, the upper and lower portions of said peripheral edge sloping downwardly from said front face toward said rear face.

7. The gasifier as claimed in claim 1 wherein the thermocouple opening includes a counterbore and the cap and the counterbore are of complementary shape to enable said cap to be recessed a predetermined amount in said counterbore.

8. The gasifier as claimed in claim 1 wherein the cap is generally disc-shaped.

9. A cap for protection of a thermocouple in a gasifier comprising,
a) a generally disc-shaped member having
i) a front face for exposure to heat of a gasifier reaction chamber,
ii) a rear face for confronting a thermocouple cavity, and
iii) a peripheral edge between said front face and said rear face,
b) said cap having a selected orientation wherein said rear face forms a vertical plane and said front face has a slag diverting section that is inclined away from said rear face in a downward direction when said cap is in said selected orientation.

10. The cap as claimed in claim 9 wherein said front face has a receding section that is below said slag diverting section when said cap is in said selected orientation, said receding section being inclined toward said rear face in an downward vertical direction when said cap is in said selected orientation.

11. The cap as claimed in claim 9 wherein a hole is formed in the receding section of said cap, said hole extending through said front face and said rear face and being inclined upwardly from said front face toward said rear face when said cap is in said selected orientation.

12. The cap as claimed in claim 10 wherein said slag diverting section is of lesser area than said receding section.

13. The cap as claimed in claim 9 wherein when said cap is in said selected orientation said peripheral edge has an upper portion and a lower portion, the upper and lower portions of said peripheral edge sloping downwardly from said front face to said rear face.

14. A method of protecting a thermocouple in a gasifier comprising,
a) forming a thermocouple cavity that extends through a reactor shell of the gasifier, through a refractory lining on the reactor shell and through a hot-face surface of the refractory lining to define a thermocouple opening at the hot-face surface, and,
b) providing a cap at said thermocouple opening in a covering position to cover said thermocouple opening and thereby prevent any slag that is formed in the gasifier on the hot-face surface from entering said thermocouple cavity through said thermocouple opening.

15. The method of claim 14 including forming a counterbore of complementary shape to the cap at the thermocouple opening to enable the cap to be recessed a predetermined amount in the thermocouple opening.

16. The method of claim 14 including providing the cap with a planar rear surface to confront the thermocouple cavity when the cap is positioned at the thermocouple opening to cover the thermocouple opening, and providing the cap with a front surface corresponding to the hot-face surface and forming an upper portion of the front surface with a slag diverting section that is inclined away from the rear surface in a downward direction when the cap is positioned in a selected orientation on the thermocouple opening.

17. The method of claim 16 including providing a through-hole in the cap to extend through the front and rear surfaces at an upward inclination toward the rear surface when the cap is in the selected orientation.

18. The method of claim 16 including forming a receding section on the front surface below the slag diverting section and providing the receding section with a slope that is inclined from the front surface toward the rear surface in a downward vertical direction when the cap is in the selected orientation.

19. The method of claim 18 including forming the slag diverting section with less area than the receding section.

20. The method of claim 14 including arranging the cap such that a front face of the cap corresponds to the hot-face surface and a rear face of the cap confronts the thermocouple cavity when the cap is in the covering position at the thermocouple opening, and providing a peripheral edge of the cap between the front and rear faces with an upper portion and a lower portion when the cap is in the covering position, and forming the upper and lower portions of the peripheral edge with a downward slope from the front face to the rear face.

21. A method of protecting the vessel or shell of a gasifier in the vicinity of a thermocouple cavity, wherein the thermocouple cavity extends through a reactor shell of the gasifier, through a refractory lining on the reactor shell and through a hot-face surface of the refractory lining to define a thermocouple opening at the hot-face surface, said method comprising
providing a cap at said thermocouple opening in a covering position to cover said thermocouple opening and to thereby minimize exposure of the vessel or shell of the gasifier to heat from within the gasifier that would otherwise pass through the thermocouple cavity to the vessel or shell of the gasifier.
